(19) United States
(12) Patent Application Publication
(10) Pub. No.: US 2005/0055125 A1
(43) Pub. Date: Mar. 10, 2005

(54) Method of monitoring the operation of a machine tool

(76) Inventors: Joachim Kappich, Bad Liebenzell (DE); Britta Stankewitz, Pforzheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/903,482

(22) Filed: Aug. 2, 2004

(30) Foreign Application Priority Data
Aug. 2, 2003 (DE) 103 35 558.8

(51) Int. Cl. G06F 19/00

(52) U.S. Cl. 700/175; 700/280

(57) ABSTRACT

A method of monitoring the operation of machine tools, wherein at least one sensor for detecting the vibrations and a predefinable number of sensors for detecting the rotational speed of the individual assemblies of a machine tool are provided. The rotational speed sensors or the rotational speeds determined from the CAN determine the center frequency of an order filter, and the vibration sensors are analyzed by way of a rotational-speed-dependent order filter.

This application claims the priority of German Patent Document no. 103 35 558.8, filed Aug. 2, 2003, the disclosure of which is expressly incorporated by reference herein.

### BACKGROUND AND SUMMARY OF THE INVENTION

The invention relates to machine tools, as known, for example, from German Patent Document DE 197 40 346 A1 which discloses that known automotive machine tools, such as combine harvesters, field choppers, tractors or constructions machines, in addition to having a drive assembly, as a rule, also have several auxiliary drives with a larger number of working assemblies.

Thus, in addition to the running drive in the form of a mechanical drive or of a hydrostatic drive arranged behind the driving engine, from which hydrostatic drive, the driving power is hydrostatically transmitted to the driving wheels, an automotive combine harvester has a plurality of working assemblies, such as cutting tools, threshing and separating elements, straw cutters, blowers, etc., which, as power take-offs, are additionally directly or indirectly driven by the engine shaft of the driving engine. For ensuring a reliable use of a machine tool for different starting situations, for example, when driving in different crop densities, when harvesting in hilly terrain, under varying soil conditions and during road driving, it is customary to monitor the operation of the individual assemblies. Since rotating components are essentially involved, it is known to provide at least one sensor for detecting vibrations and to assign a rotational speed sensor to the elements to be monitored. The rotational speed sensor detects the rotational frequency of the elements to be monitored, so that, in an analyzing device, the rotational speed movement frequencies detected in the entire driving system are assigned to the signals of the movement and/or vibration sensor, so that both data are mutually correlated. The comparison with filed values for the amplitude and the frequency of the signal permits an assignment as to whether a fault is present in the system.

Based on these known interrelationships, it is an object of the invention to find an improved fault detection which ensures that, also for different use conditions of the machine tool, deviations can be reliably recognized.

The method according to the present invention has the advantage that, by means of the utilization of rotational-speed-dependent filters, clearer information can be obtained as to whether a fault is present. The frequency of the individual components changes with the rotational speed, so that a filtering with fixed frequencies is not useful as, under certain circumstances, faults cannot be reliably detected. In the case of rotating and oscillating elements, a direct connection exists between the rotational speed and a multiple of the rotational speed of the element and the frequencies excited by the latter. It can therefore be assumed that changes in the function of the element cause a change of the amplitude of these frequencies.

Other objects, advantages and novel features of the present invention will become apparent from the following detailed description of the invention when considered in conjunction with the accompanying drawings.

### BRIEF DESCRIPTION OF THE DRAWINGS

The method according to the invention is illustrated in the drawing and will be explained in detail in the following description.

FIG. 1 is a schematic diagram of an automotive machine tool; and

FIG. 2 is a schematic flow chart for implementing the monitoring of operations of a machine tool by means of a rotational-speed dependent filter.

### DETAILED DESCRIPTION OF THE PREFERRED EMBODIMENT

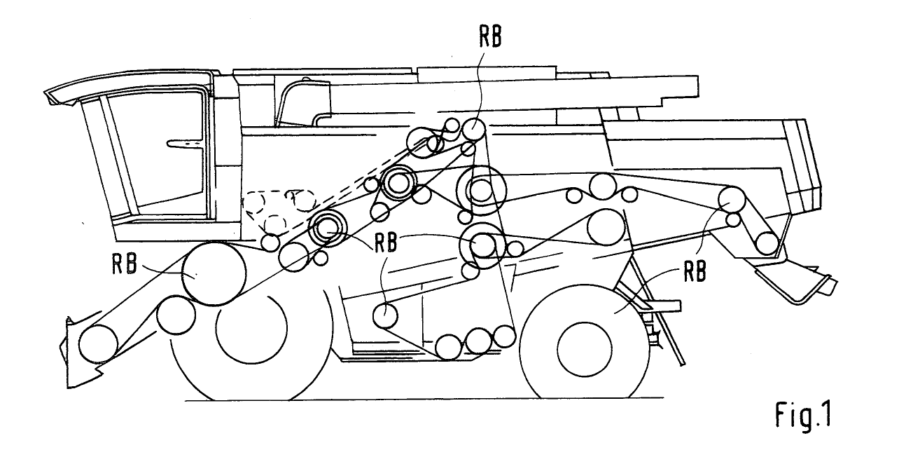

FIG. 1 is shown only for illustrating the large number of rotating components which are marked by the reference symbol RB in FIG. 1 and show the complexity of an automatic machine tool.

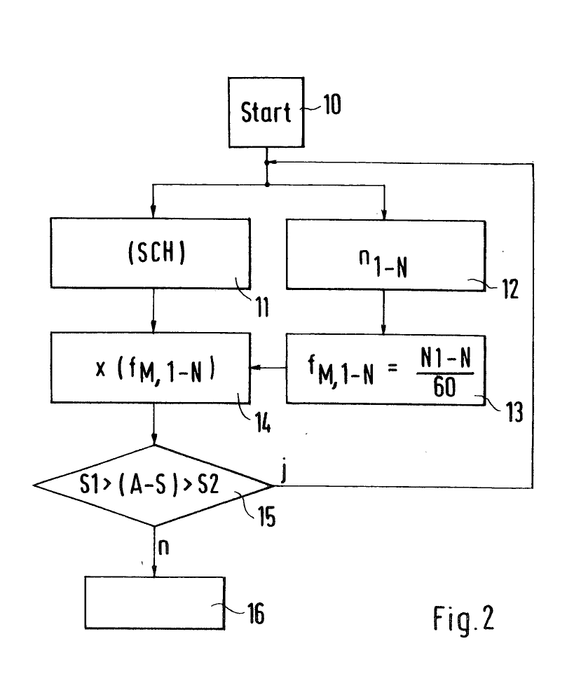

The method according to the invention itself will now be explained by means of FIG. 2. After the start 10 of the process for monitoring the operation of the machine tool, in a Step 11, the signals of at least one vibration sensor, not shown here, are detected and are filed as a vibration signal x(SCH) for a further processing. In a parallel working Step 12, the signals are detected by rotational speed sensors, which are also not illustrated in the figures, and the determined rotational speed values n are input to a next working Step 13. The number 1 to x of the rotational speed sensors, which supply the respective rotational speed values n₁. _{N}, and the respective mounting site can be determined, for example, in the application. Furthermore, the rotational speeds of individual components can be determined directly or by way of corresponding transmission ratios from the CAN (Controller Area Network).

On the basis of the determined rotational speed n, the center frequency f_{M,1-N} of order filters connected on the output side is defined in Step 13, so that, in Step 14, the detected vibrations x(SCH) are filtered by means of a rotational-speed-depending order filter. The thus processed signals of the vibration filters are compared with different filed threshold value in the subsequent Step 15.

In this case, a comparison takes place with a first threshold value S1 which is negative. This comparison determines whether the amplitude of the order-filter-processed signal is significantly larger than the comparative value.

Furthermore, it is checked whether the difference between the amplitude A of the order-filter-processed signal and a comparative value S (desired value) is smaller than a second stored threshold value S2. If the amplitude of the order-filter-processed signal minus the comparative value is larger than the second threshold value S2, this indicates excessive vibrations.

If the amplitude of the order-filter-processed signal minus the comparative value is smaller than the first threshold value S1, this indicates that the element is not driven properly. In both cases, a fault report is emitted in a subsequent Step 16.

If no exceeding of the threshold value S1 and no falling below the threshold value S2 could be determined, the system recognizes that the machine tool is operating properly and moves back to the start of the process. Another monitoring then starts in Step 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method of monitoring operation of a machine tool using at least one sensor for detecting vibrations and a plurality of sensors for detecting rotational speed of individual assemblies of the machine tool, said method comprising the steps of:
detecting rotational speed of an assembly;
determining a center frequency of an order filter as a function of said detected rotational speed;
detecting vibration signals of said machine tool; and
analyzing said vibration signal by means of a rotational-speed dependent order filter.

2. The method according to claim 1, further comprising the step of providing a fault report when a filter signal of the vibration sensors is outside a predefined band with.

3. The method according to claim 2, wherein an amplitude of the filter vibration signal is reduced by a desired value.

4. A method for monitoring operation of a machine tool comprising the steps of:
detecting vibration of said machine tool and outputting a vibration signal;
detecting rotational speed values related to rotating components of said machine and outputting a plurality of speed signals;
determining a center frequency of an order filter as a function of said rotational speed signals;
filtering said detected vibration signals as a function of said center frequency; and
comparing said filter vibration signal with at least one predetermined value.

5. The method according to claim 1, providing a fault indication as a function of the comparing step.

6. The method according to claim 4, wherein an amplitude of the vibration signal is reduced by a predetermined value prior to a comparing step.
